(19) United States
(12) Patent Application Publication
(10) Pub. No.: US 2007/0212482 A1
(43) Pub. Date: Sep. 13, 2007

(54) METHOD OF TREATING PARTICLES

(76) Inventors: James Nevin, Lake Worth, FL (US); Jay R. Garner, Clute, TX (US); Dominick A. Burlone, Lake Jackson, TX (US); Paul R. Meiller, Lake Jackson, TX (US); R. Merritt Sink, Lake Jackson, TX (US); Judy Easterling, Angleton, TX (US); Erik Mayer, Prairieville, LA (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/276,701

(22) Filed: Mar. 10, 2006

(51) Int. Cl. B05D 7/00; B05D 1/02

(52) U.S. Cl. 427/212; 427/421.1

(57) ABSTRACT

A method of treating granules with a coating utilizing an apparatus having a feed chute, a diffuser mounted adjacent the feed chute, a spray nozzle, and an exit chute having a deflector disposed below the diffuser and spray nozzle. The method comprises the steps of: feeding the granules into the feed chute; intersecting the granules with an angled wall of the diffuser to create a curtain of granules falling about a base of the diffuser; spraying the coating from the spray nozzle downwardly away from the diffuser toward the deflector of the exit chute in a predetermined conical pattern; and intersecting the granules with the deflector to redirect the granules into the conical pattern of the coating for treating each of the granules with the coating. The subject invention provides a method of efficiently treating a large throughput of granules with an appropriate amount of coating.

### BACKGROUND OF THE INVENTION

1. Field of the Invention

The subject invention relates to a method of treating a plurality of particles with a coating, such as treating a plurality of ammonium sulfate granules with an anticaking agent.

2. Description of Related Art

The prior art is replete with various methods of applying coatings, typically in a liquid form, to solid particles. Many of these prior art systems use a horizontally rotational chamber or drum where a stream of a liquid coating is applied as the particles roll within the drum. Examples of these drum type systems are disclosed in U.S. Pat. Nos. 5,443,637 and 5,501,874. These drum systems require large amounts of space and energy to operate. Also, these systems can be expensive to construct, maintain and install. Other prior art systems utilize other rotational parts for applying the coating, which can likewise be expensive and are also prone to failure. For example, U.S. Pat. Nos. 4,596,206 and 2,862,511 utilize rotary applicators for applying a liquid coating. As other examples, U.S. Pat. No. 4,275,682 utilizes rotating conical plates for dispersing the liquid coating and U.S. Pat. No. 4,520,754 discloses a device that applies an electrical charge to the particles, which are then coated by a rotational applicator with the coating containing an opposite charge.

In order to avoid the pitfalls with the above designs, the prior art has developed alternative systems, such as shown in U.S. Pat. No, 5,993,903, which minimize the number of moving parts. The '903 patent discloses a device having a number converging and diverging conical cones with a number of spray applicators disposed along a length thereof. The '903 patent, however, does not optimize a throughput of the number of particles passing through the device with an amount of coating being sprayed In other words, the '903 patent fails to provide an optimum throughput of particles relative to the amount of coating being sprayed to achieve a desired percentage of particles covered. The '903 patent simply sprays the particles at each intersection of the converging and diverging cones without any efforts to optimize the efficiency of the coating process.

Accordingly, there remains a need to develop a device with a minimal number of moving parts that efficiently treats a relatively large throughput of particles through the device with a minimal amount of coating yet achieving a desired percentage of particles being covered.

### SUMMARY OF THE INVENTION AND ADVANTAGES

The subject invention includes a method of treating a plurality of particles with a coating utilizing an apparatus having a feed chute, a diffuser mounted adjacent the feed chute, an applicator, and an exit chute having a deflector disposed below the diffuser and applicator. The method comprises the steps of: feeding the plurality of particles into the feed chute; intersecting the particles with the diffuser to create a curtain of particles falling about the diffuser; spraying the coating from the applicator downwardly away from the diffuser toward the deflector of the exit chute in a predetermined pattern; and intersecting the particles with the deflector to redirect the particles into the predetermined pattern of the coating for treating each of the particles with the coating.

Accordingly, the subject invention provides an apparatus and a method of efficiently treating a large amount of particles with a minimal amount of coating by spraying the coating in a particular manner and controlling the flow of the particles to direct the particles into the sprayed coating.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a partially fragmentary side view of an apparatus incorporating the subject invention;

FIG. 2 is a partially fragmentary end view of the apparatus;

FIG. 3 is a perspective view of a diffuser within a diffuser housing;

FIG. 4 is a partially fragmentary side view of the diffuser and diffuser housing;

FIG. 5 is another side view of the diffuser housing;

FIG. 6 is yet another side view of the diffuser housing;

FIG. 7 is a side view of the diffuser;

FIG. 8 is a partially fragmented perspective view of a sub-assembly of the apparatus schematically illustrating a feed chute, the diffuser, an applicator, and an exit chute;

FIG. 9 is a partially cross-sectional schematic view of the sub-assembly with a plurality of particles passing therethrough;

FIG. 10 is another partially cross-sectional schematic view of the sub-assembly with a single particle passing therethrough;

FIG. 11 is a partially cross-sectional schematic view of an alternative sub-assembly of the apparatus having an outer chamber, the diffuser, the applicator, and a deflector;

FIG. 12 is a partially cross-sectional schematic view of a series of the sub-assemblies of FIG. 11;

FIG. 13 is a partially cross-sectional schematic view of another alternative embodiment of the sub-assembly wherein the diffuser is automatically adjustable;

FIG. 14 is a partially cross-sectional view of the diffuser and feed chute illustrating various widthwise dimensions of the diffuser and the adjustability of the feed chute;

FIG. 15 is a partially cross-sectional schematic view of the diffuser and the feed chute having a bladder in an inflated position; and

FIG. 16 is a partially cross-sectional schematic view of the diffuser and the feed chute having the bladder in a deflated position.

### DETAILED DESCRIPTION OF THE INVENTION

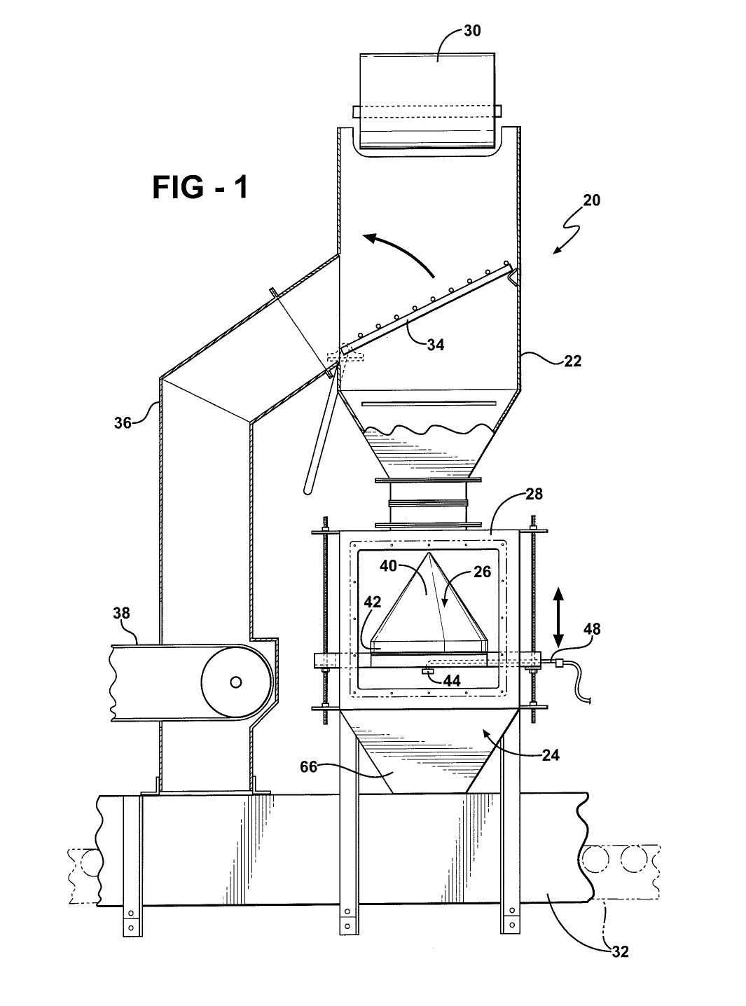

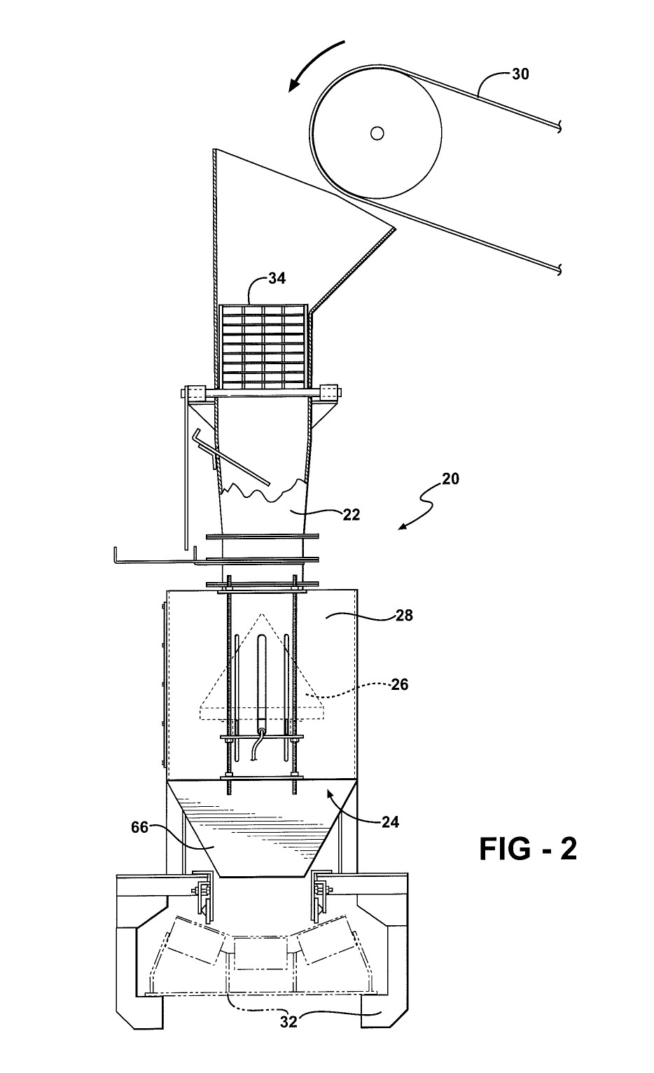

Referring to the Figures, wherein like numerals indicate like or corresponding parts throughout the several views, an apparatus in accordance with the subject invention is generally shown at 20 in FIGS. 1 and 2. The apparatus 20 includes a feed chute 22 and an exit chute 24. Both the feed 22 and exit 24 chutes are preferably configured as hoppers having angled walls at an inlet thereof. A diffuser 26 and a diffuser housing 28, which are discussed in greater detail below, are disposed between the feed 22 and exit 24 chutes. A feed conveyor 30 is preferably disposed over the feed chute 22 to provide a desired inflow of particles (not shown in this Figure). An exit conveyor 32 is preferably disposed below the exit chute 24 to capture and transport treated particles as the particles are discharged from the apparatus 20. The feed chute 22, exit chute 24, and conveyors 30, 32 are know to those skilled in the art and may be of any suitable design or configuration.

A screen 34 is disposed within the feed chute 22 for sifting the plurality of particles before the particles intersect the diffuser 26. The screen 34 has a plurality of openings of a predetermined size wherein any particles larger than this predetermined size cannot pass through the screen 34. It should be appreciated that the openings may be of any suitable size or configuration. In one contemplated embodiment, the size of the openings is one square inch. Preferably, the size of the openings is based on the size of a gap between the feed chute 22 and the diffuser 26. The screen 34 is therefore provided to prevent clogging of the particles between the feed chute 22 and the diffuser 26. As shown in FIG. 1, a bypass chute 36 is aligned with the screen 34 such that any particles larger than the predetermined size are redirected into the bypass chute 36. A bypass conveyor 38 collects the particles larger than the predetermined size as the particles are discharged from the bypass chute 36.

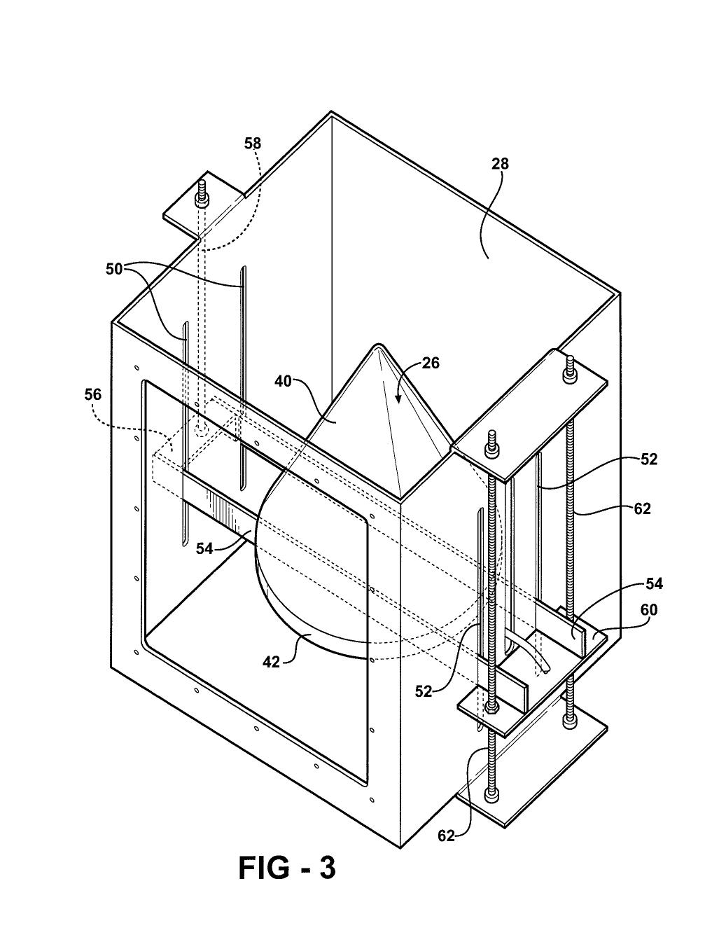

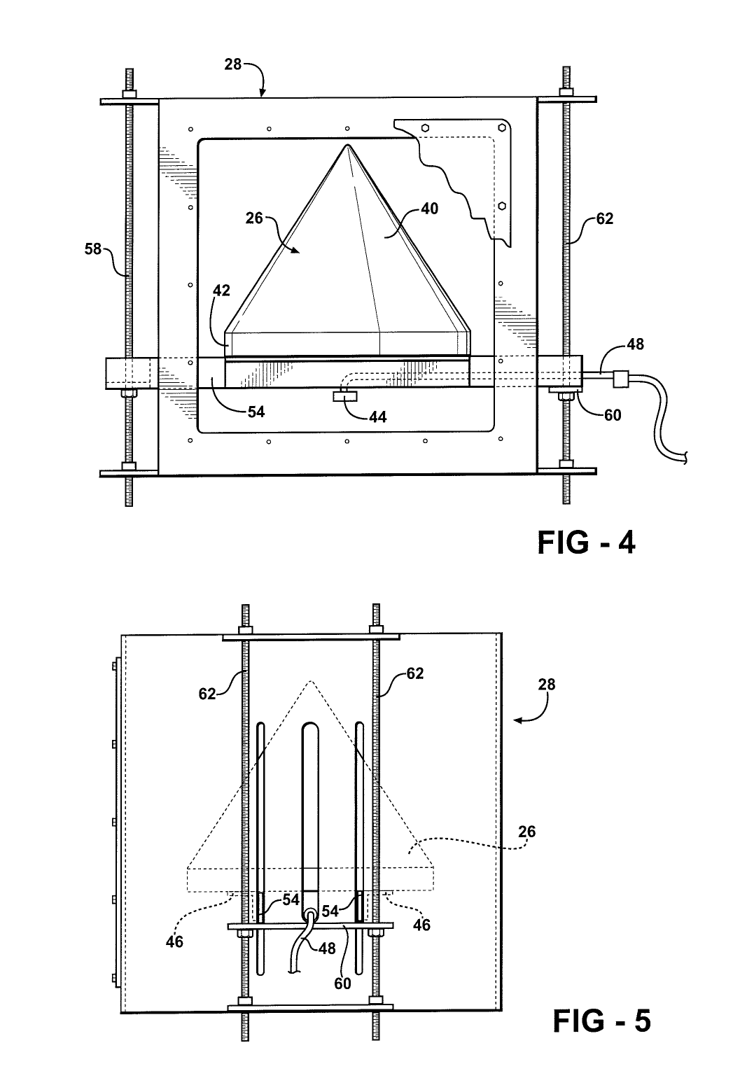

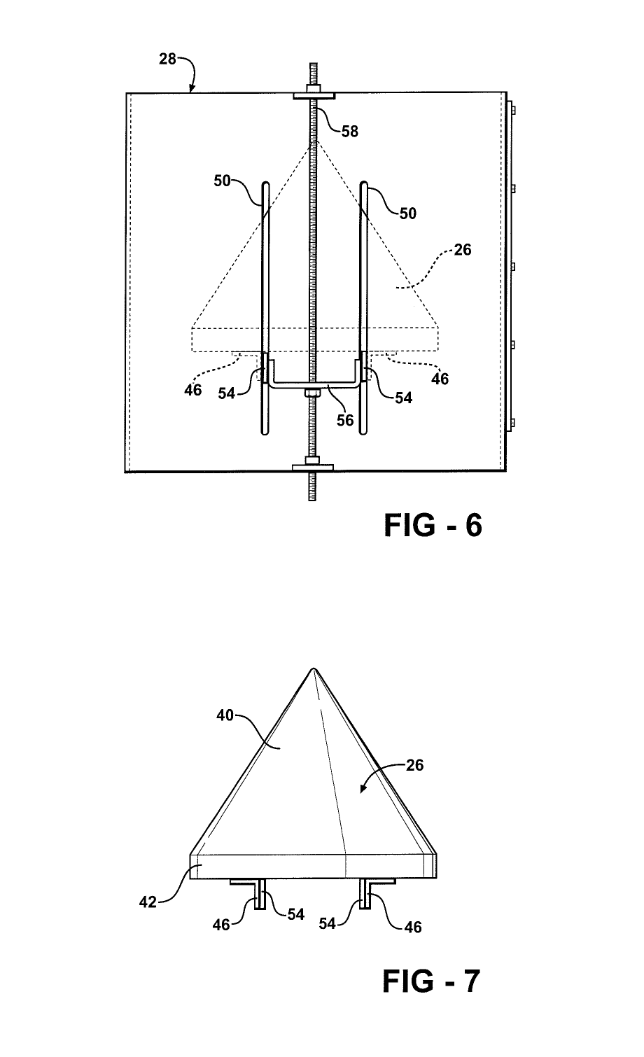

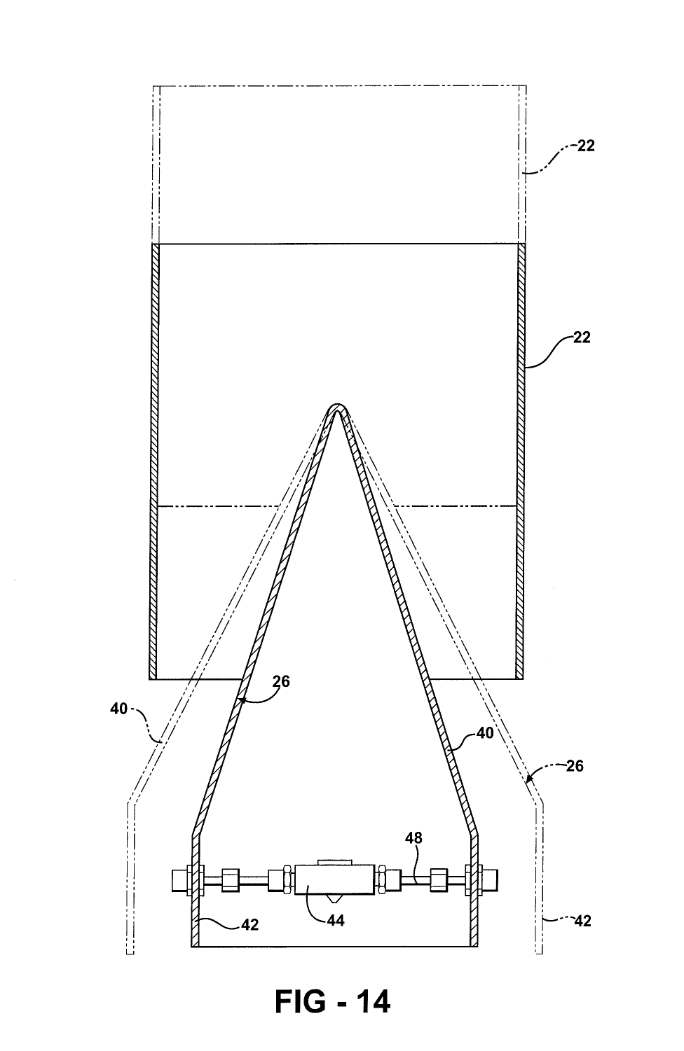

Turning also to FIGS. 3-6, the diffuser 26 and diffuser housing 28 are shown in greater detail 7. The diffuser 26 has an angled wall 40 and a base 42 to define a generally cone shaped configuration. The base 42 of the diffuser 26 includes a pair of flanges 46 extending downwardly therefrom. As shown in FIG. 14, the angled wall 40 of the diffuser 26 may be of any suitable slope so long as a desired gap between the diffuser 26 and the feed chute 22 is maintained. Further, the diffuser 26 may be of any suitable configuration as is needed.

An applicator 44, or spray nozzle, is mounted adjacent to the base 42 of the diffuser 26. The applicator 44 is preferably mounted centrally under the diffuser 26 to reduce the likelihood of damage or clogging from the particles. An inlet pipe 48 is connected to the applicator 44 to provide the requisite coating material to the applicator 44. As discussed in greater detail below, the applicator 44 sprays a coating downwardly away from the diffuser 26. Applicators 44 that are suitable for the subject invention are well known in the art and will therefore not be discussed in any greater detail.

The diffuser housing 28 includes four walls forming a substantially box shaped structure with one of the walls having a window disposed therein. A first pair of slots 50 is formed in one of the walls and a second pair of slots 52 is formed in an opposing wall aligned with the first pair of slots 50. A pair of rails 54 extend across the diffuser housing 28 with each first end exiting out of corresponding first slots 50 and each second end exiting out of corresponding second slots 52. The first ends of the rails 54 are interconnected by a bracket 56. A first threaded shaft 58 interconnects the bracket 56 to the diffuser housing 28. The second ends of the rails 54 are mounted to a plate 60. Preferably a pair of second threaded shafts 62 interconnect the plate 60 to the diffuser housing 28. The flanges 46 of the diffuser 26 are mounted to the rails 54 to mount the diffuser 26 to the diffuser housing 28. The rails 54, bracket 56, plate 60, and threaded shafts 58, 62 provide an adjustment mechanism for adjusting a height of the diffuser 26 relative to the diffuser housing 28. Further, the adjustment mechanism adjusts a height of the diffuser 26 relative to the feed chute 22 to define a desired gap between the diffuser 26 and feed chute 22. Preferably, the height of the diffuser 26 is secured relative to the feed chute 22 prior to the operation of the apparatus 20.

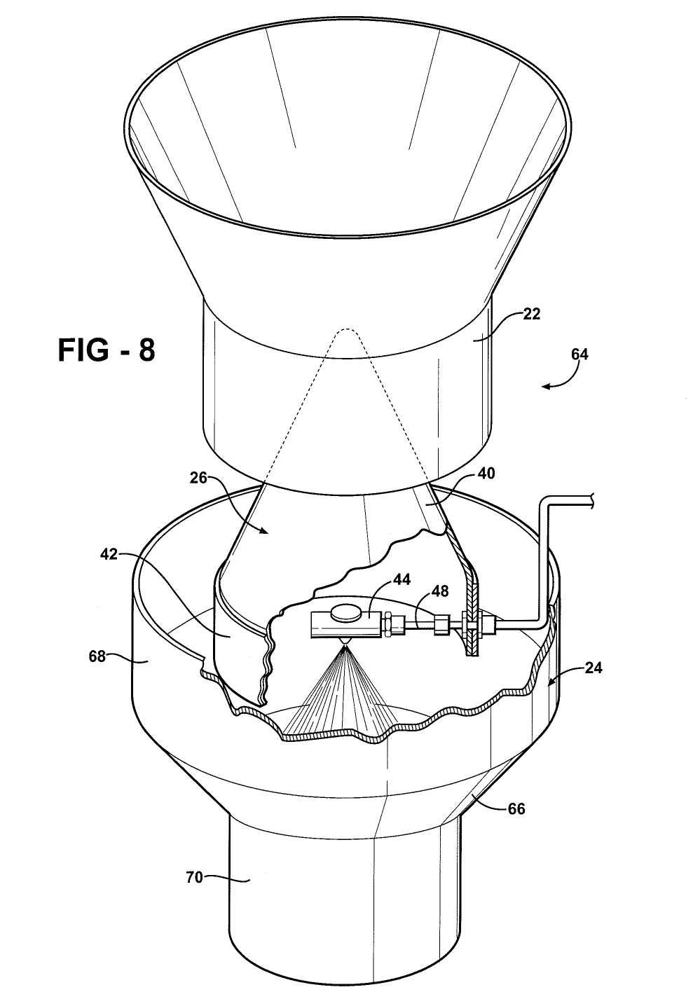

As also shown in FIGS. 8-10, a sub-assembly 64 of the apparatus 20 is schematically shown at 64. The sub-assembly 64 includes the feed chute 22, diffuser 26, applicator 44, and exit chute 24. In order to best illustrate some of the operational features of the invention, many of the mounting components are removed in these Figures such that this sub-assembly 64 is somewhat schematic in detail. In FIGS. 8-10, the applicator 44 is mounted to the base 42 of the diffuser 26 through the inlet pipe 48.

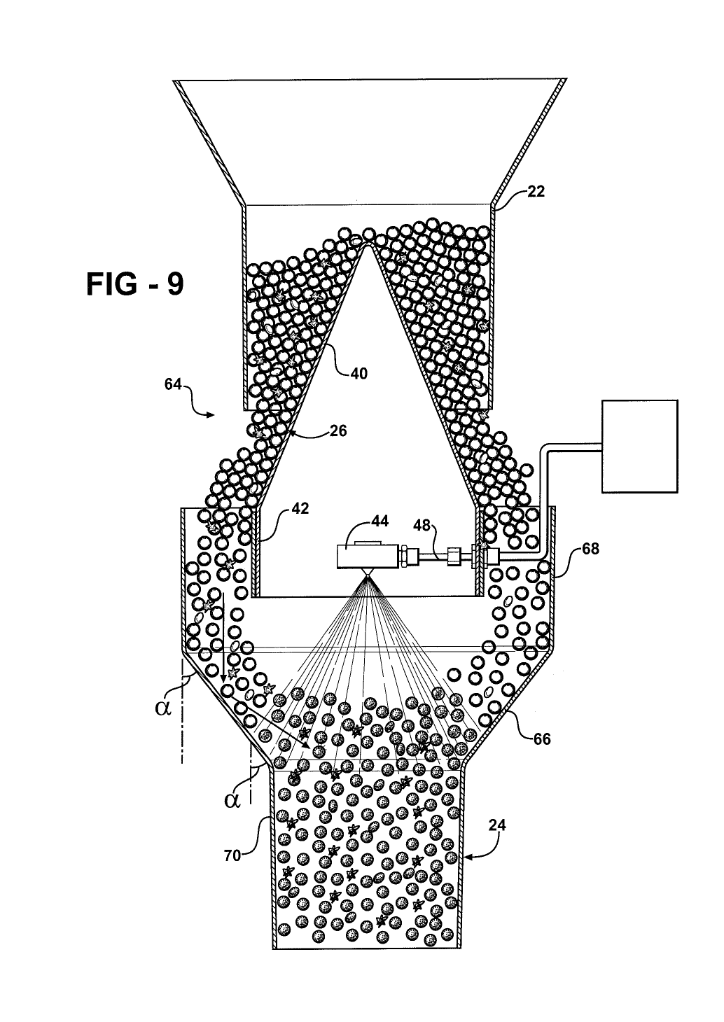

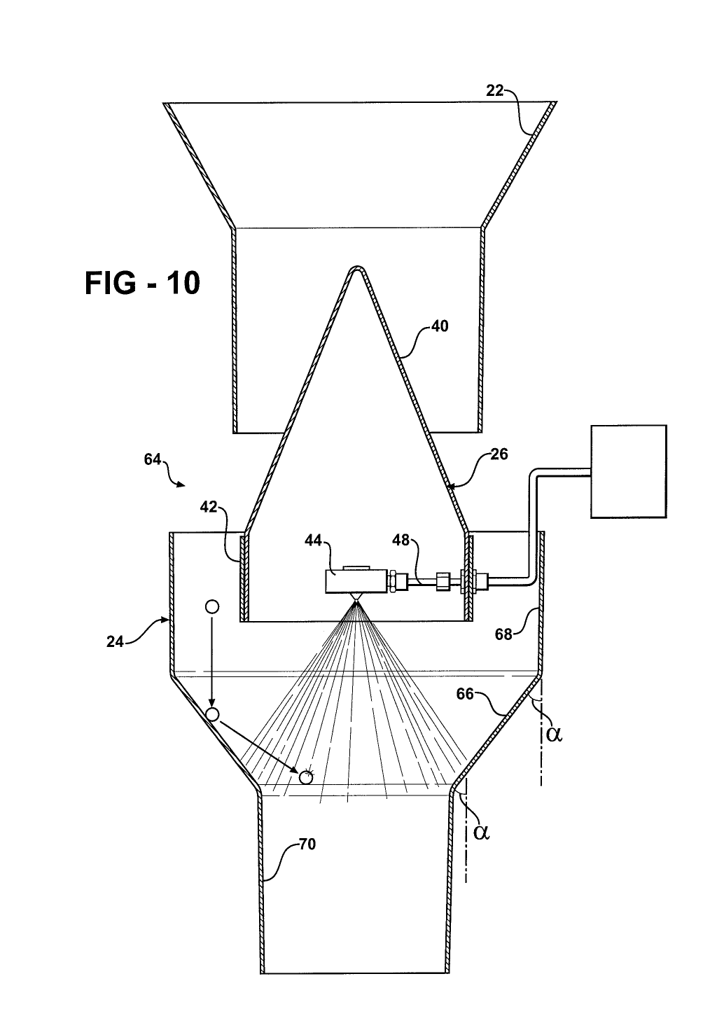

As best shown in FIGS. 1-2 and 9-10, the exit chute 24 includes a deflector 66 disposed below the diffuser 26 and applicator 44. In the embodiment of FIGS. 9 and 10, the exit chute 24 includes a capture portion 68 and a discharge portion 70 which is smaller in diameter than the capture portion 68. The deflector 66 is angularly positioned between the larger capture portion 68 and the smaller discharge portion 70. The deflector 66 is angled in such a manner as to adequately redirect the particles without clogging the exit chute 24 or interfering with the operation of the applicator 44. Preferably, the capture portion 68 of the exit chute 24 is positioned adjacent the diffuser 26 for positioning the deflector 66 adjacent the base 42. The deflector 66 cuts across the base 42 such that an entire curtain of particles falling from the base 42 will be redirected by the deflector 66. The deflector 66 may be mounted directly to the diffuser housing 28, such as shown in FIGS. 1 and 2. As best shown in FIGS. 9 and 10, the angle a of the deflector 66 relative to the base 42 of the diffuser 26 or the capture portion 68 of the exit chute 24 may be from 45 to 80 degrees and is preferably 60 degrees.

FIG. 9 illustrates a plurality of particles passing through the sub-assembly 64 and FIG. 10 illustrates a single particle passing through the sub-assembly 64. Preferably, the plurality of particles is further defined as a plurality of granules Even more preferably, the plurality of granules are further defined as a plurality of ammonium sulfate granules, such as the type used in fertilizer applications The granules can be in the shaped of spheres, ovals or any other suitable configuration.

The particular method steps of treating the plurality of particles with the coating utilizing the apparatus 20 of the preferred embodiment will now be discussed in detail with reference to FIGS. 8-10. Initially, the plurality of particles are fed into the feed chute 22 from the feed conveyor 30. The particles intersect the diffuser 26 to create a curtain of particles falling about the diffuser 26. Preferably, the particles intersect the angled wall 40 to create a curtain of particles falling about the base 42. As discussed above, a height of the diffuser 26 can be adjusted relative to the feed chute 22. Preferably, the height of the diffuser 26 is secured relative to the feed chute 22 prior to the step of intersecting the particles with the diffuser 26.

The plurality of particles pass through the feed chute 22 and about the diffuser 26 at a high throughput rate such that the subject invention can efficiently treat a large volume of particles in a relatively short period of time. It should be appreciated that the speed of the material passing through the apparatus 20 can vary depending upon the type of particle and particle size. One non-limiting example includes the throughput of the particles passing through the feed chute 22 and about the diffuser 26 at a rate of 200 to 40,000 lbs per hour As another non-limiting example, the throughput of the particles can pass through the feed chute 22 and about the diffuser 26 at a rate of 10,000 to 25,000 lbs per hour. The throughput of the particles can be determined by any suitable device or calculation

The coating is sprayed from the applicator 44 downwardly away from the diffuser 26 toward the deflector 66 of the exit chute 24 in a predetermined pattern. In the embodiment illustrated, the coating is sprayed downwardly in a cone shaped pattern defining an outer periphery of the sprayed coating It should be appreciated that the coating could be sprayed in alternative patterns so long as the coating is sprayed downwardly toward the deflector 66. The coating may be sprayed downwardly in a hollow cone shaped pattern for spraying a substantial portion of the coating directly toward the deflector 66. Alternatively, the coating may be sprayed downwardly in a solid cone shaped pattern for spraying a portion of the coating directly toward the deflector 66 and spraying another portion of the coating below the deflector 66 into the discharge portion 70 of the exit chute 24 In either case, the outer periphery of the coating will intersect a portion of the deflector 66. As illustrated, the outer periphery of the coating intersects the deflector 66 at approximately the width of the base 42 of the diffuser 26. Preferably, the coating is further defined as an anticaking agent. Even more preferably, the coating is petroleum wax that is heated before being sprayed.

The curtain of particles falling from the base 42 of the diffuser 26 intersect with the deflector 66 to redirect the particles into the predetermined pattern of the coating for treating each of the particles with the coating. Preferably, the particles intersect with the deflector 66 to redirect the particles into the pattern before any of the particles are treated with the coating. In other words, the particles remain untreated as the curtain of particles fall about the diffuser 26 and are redirected by the deflector 66. Hence, the particles are only treated after the particles change direction into the outer periphery of the sprayed coating. This feature of the invention is perhaps best illustrated in FIG. 10.

Due to the spray pattern and the redirection of the particles, the coating can be sprayed in a relatively low throughput rate in comparison to the high throughput rate of particles passing through the apparatus 20. Again, it should be appreciated that the coating may be sprayed at any suitable rate without deviating from the overall scope of the subject invention. In one non-limiting example, the coating can be sprayed at a rate of 15 to 80 lbs per hour, preferably twenty-five lbs per hour. Preferably, at least twenty five percent of the particles intersecting the deflector are treated during the process. Even more preferably, approximately thirty-five to fifty percent of the particles intersecting the deflector are treated. As non-limiting examples, it has been found that less than fifty percent of ammonium sulfate particles need to be covered to prevent anti-caking of these particles. As another non-limiting example, it has been found that nearly one-hundred percent of ammonium nitrate particles need to be covered to prevent anti-caking of these particles. It should be appreciated, that the percent of coverage for the particles is dependent upon the type of particle, size of the particle, atmospheric conditions, as well as a number of other factors. Hence, the percent of coverage can vary greatly without deviating from the overall scope of the subject invention. The subject invention therefore defines an efficient method treating a large amount of particles with a minimal amount of coating by spraying the coating in a particular manner and controlling the flow of the particles to direct the particles into the sprayed coating.

The treated particles are then discharged out of the exit chute 24 and accumulate along the exit conveyors 32. As discussed above, particles that exceed a predetermined size will be re-routed down a bypass chute 36 to a bypass conveyor 38.

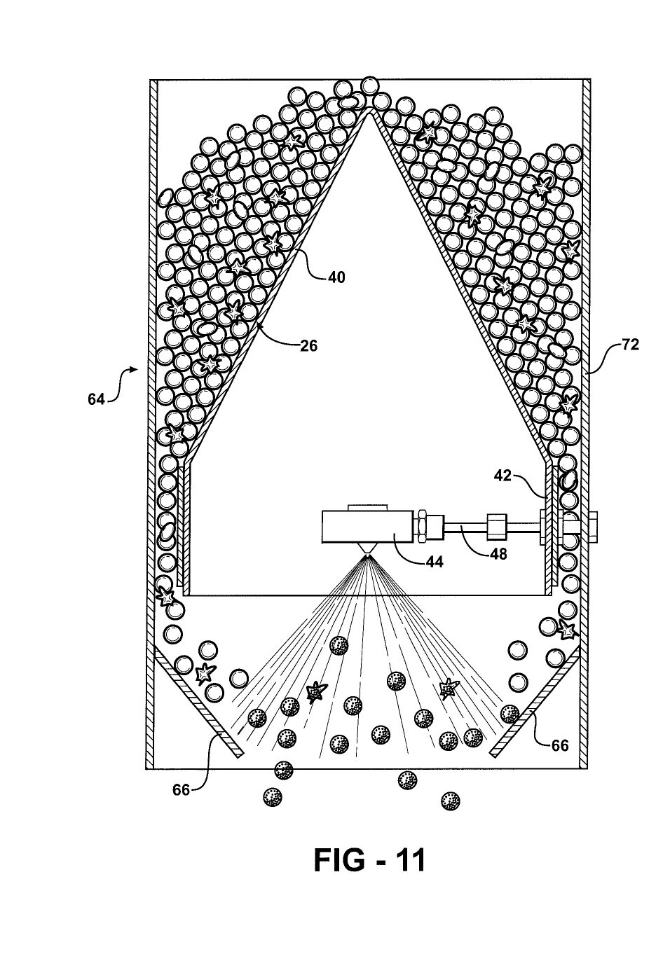

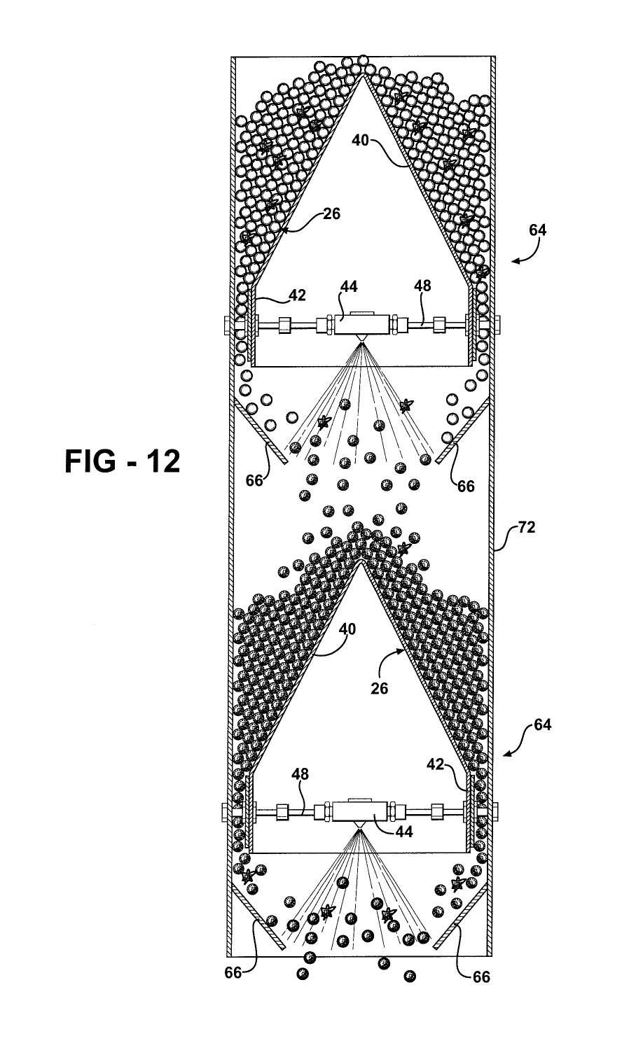

Referring to FIGS. 11 and 12, an alternative sub-assembly 64 of the apparatus 20 is generally shown. This alternative sub-assembly 64 incorporates a different structure to perform virtually the same efficient treating steps set forth above. In particular, the alternative sub-assembly 64 includes an outer chamber 72, the diffuser 26, the applicator 44, and an alternatively configured deflector 66. The outer chamber 72 can define both the feed chute and the exit chute and can be of any suitable size and configuration. Alternatively, the feed chute and/or exit chute could be separate components mounted to the outer chamber 72. The diffuser 26 and applicator 44 have virtually the same configuration. The deflector 66, however, is an angled wall 66 extending inwardly from the outer chamber 72. The configuration of the sub-assembly 64 shown in FIG. 11 can be stacked in series, such as shown in FIG. 12, to increase the coverage percentage of the particles, if desired.

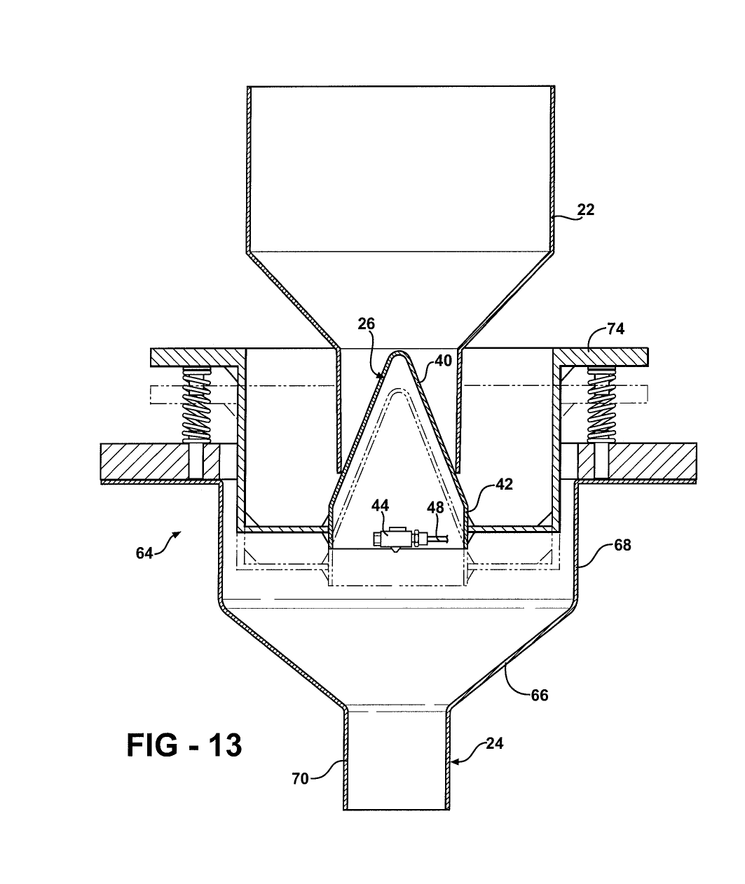

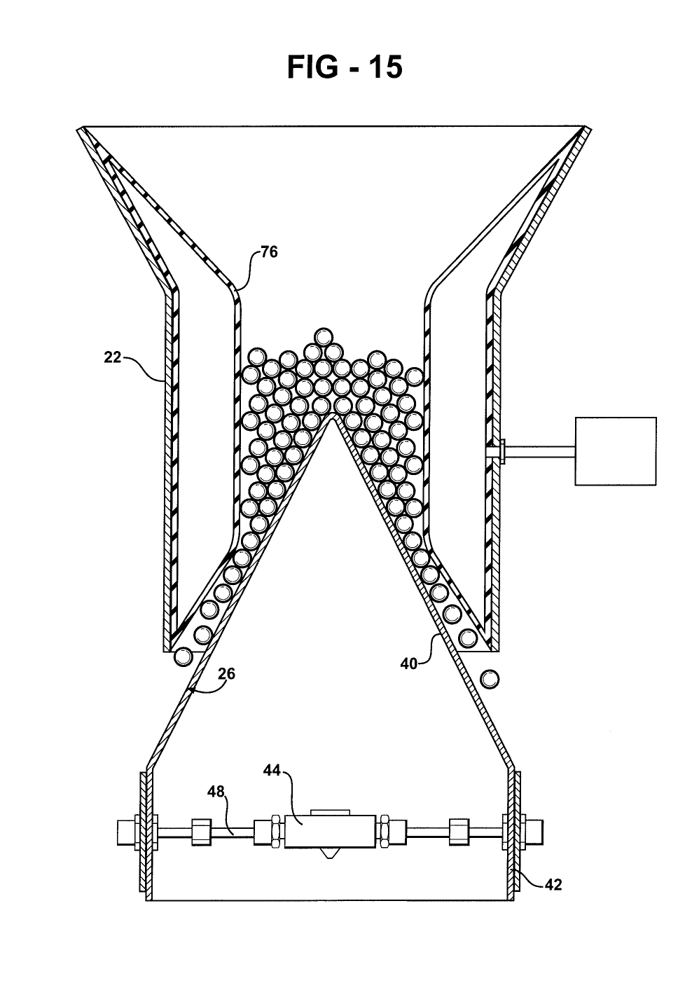

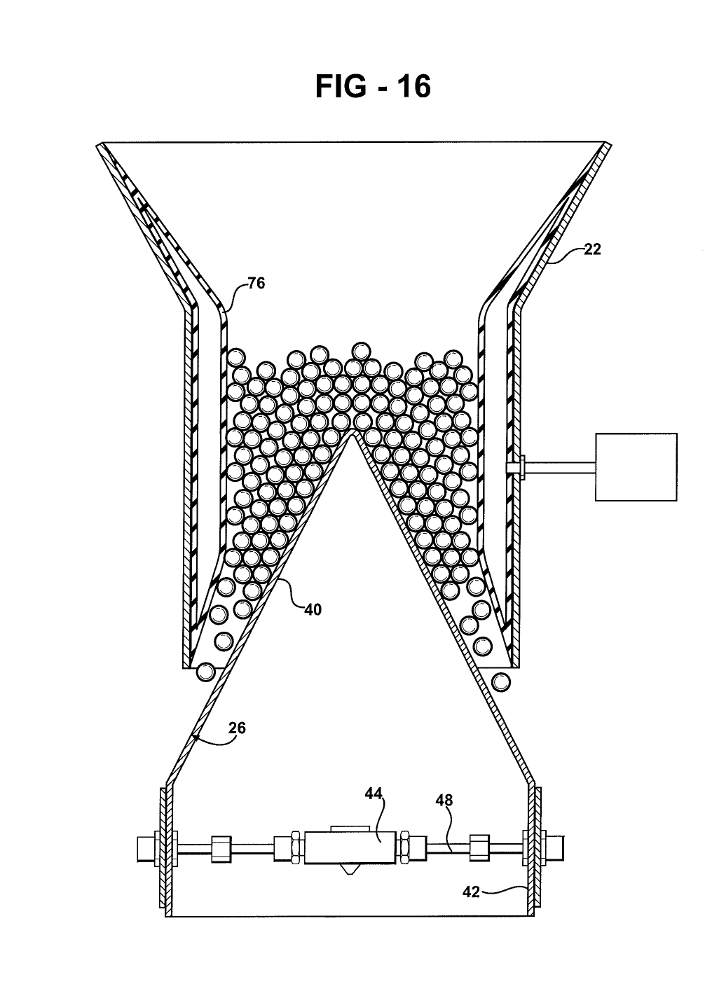

Additional alternative embodiments are shown in FIGS. 13-16 wherein various portions of the subject invention can be automatically adjusted to prevent clogging of the apparatus 20. As shown in FIG. 13, the diffuser 26 can be automatically adjusted relative to the feed chute 22 through the use of a spring biased support plate 74. The momentum and weight of the particles against the diffuser 26 will automatically move the diffuser 26 downwardly relative to the feed chute 22 to provide the requisite gap between the diffuser 26 and the feed chute 22. FIG. 14 illustrates the automatic movement of the feed chute 22 relative to the diffuser 26. In other words, the feed chute 22 can move upwardly and downwardly to define the desired gap between the feed chute 22 and the diffuser 26. Turning to FIGS. 15 16, a bladder 76 may be mounted to an inner wall of the feed chute 22 to again define the gap between the feed chute 22 and the diffuser 26. As shown in FIG. 15, the bladder 76 may be inflated to define a relatively narrow gap or, as shown in FIG. 16, the bladder 76 may be deflated to define a larger gap between the feed chute 22 and the diffuser 26.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims the invention may be practiced otherwise than as specifically described.

What is claimed is:

1. A method of treating a plurality of particles with a coating utilizing an apparatus having a feed chute, a diffuser mounted adjacent the feed chute, an applicator, and an exit chute having a deflector disposed below the diffuser and applicator; said method comprising the steps of:
feeding the plurality of particles into the feed chute;
intersecting the particles with the diffuser to create a curtain of particles falling about the diffuser;
spraying the coating from the applicator downwardly away from the diffuser toward the deflector of the exit chute in a predetermined pattern; and
intersecting the particles with the deflector to redirect the particles into the predetermined pattern of the coating for treating each of the particles with the coating.

2. A method as set forth in claim 1 wherein the step of intersecting the particles with the deflector to redirect the particles into the pattern is performed before any of the particles are treated with the coating.

3. A method as set forth in claim 1 wherein the step of spraying the coating includes the step of spraying the coating downwardly in a cone shaped pattern defining an outer periphery of the sprayed coating.

4. A method as set forth in claim 3 wherein the step of intersecting the particles with the defector is further defined as redirecting the particles toward the outer periphery of the sprayed coating.

5. A method as set forth in claim 3 wherein the step of spaying the coating is further defined as spraying the coating downwardly in a hollow cone shaped pattern for spraying a substantial portion of the coating directly toward the deflector.

6. A method as set forth in claim 3 wherein the step of spaying the coating is further defined as spraying the coating downwardly in a solid cone shaped pattern for spraying a portion of the coating directly toward the deflector and spraying another portion of the coating below the deflector into the exit chute.

7. A method as set forth in claim 1 wherein the diffuser has an angled wall and a base and the step of intersecting the particles with the diffuser includes the step of intersecting the particles with the angled wall to create a curtain of particles falling about the base.

8. A method as set forth in claim 7 further including the step of positioning the exit chute adjacent the diffuser for positioning the deflector adjacent the base.

9. A method as set forth in claim 1 further including the step of sifting the plurality of particles before the step of intersecting the particles with the diffuser for preventing clogging of the particles between the feed chute and the diffuser.

10. A method as set forth in claim 9 further including the step of discharging particles larger than a predetermined size after the step of sifting the plurality of particles.

11. A method as set forth in claim 1 further including the step of discharging treated particles out of the exit chute.

12. A method as set forth in claim 11 further including the step of accumulating the treated particles onto a conveyor.

13. A method as set forth in claim 1 further including the step of heating the coating before the step of spraying the coating.

14. A method as set forth in claim 1 further including the step of adjusting a height of the diffuser relative to the feed chute.

15. A method as set forth in claim 14 further including the step of securing the height of the diffuser relative to the feed chute prior to the step of intersecting the particles with the diffuser.

16. A method as set forth in claim 1 wherein the steps of intersecting the particles with the deflector and treating each of the particles is further defined as treating at least twenty five percent of the particles intersecting the deflector.

17. A method as set forth in claim 16 wherein the steps of intersecting the particles with the deflector and treating each of the particles is further defined as treating approximately thirty-five to fifty percent of the particles intersecting the deflector.
